(19) United States
(12) Patent Application Publication
(10) Pub. No.: US 2026/0336506 A1
(43) Pub. Date: Oct. 29, 2026

(54) DEPLOYABLE CARGO DEPENDENT RETENTION COLUMNS

(71) Applicant: Toyota Motor Engineering & Manufacturing North America, Inc., Plano, TX (US)

(72) Inventor: Winston E. Robertson, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/187,522

(22) Filed: Apr. 23, 2025

(51) Int. Cl. B60P 7/135

(52) U.S. Cl. CPC B60P 7/135

(57) ABSTRACT

A cargo retention system for a vehicle includes a cargo support structure including a fluid cavity, a cargo support surface, and a plurality of cargo retention columns coupled to the cargo support structure and moveable between a retracted position and an extended position with respect to the cargo support surface. The fluid cavity is configured to receive a pressurized fluid for urging the plurality of cargo retention columns to move from the retracted position toward the extended position. The cargo retention columns can be configured to secure one or more items on the cargo support surface to mitigate movement of the item(s) during transit.

### BACKGROUND

### 1. Field

The various aspects and embodiments described herein relate generally to cargo systems for vehicles and, in particular, to systems and apparatuses for preventing or reducing cargo movement.

### 2. Description of the Related Art

Many vehicles include cargo regions. Cargo is often held in place using tie-down straps. Tie-down straps are typically tightened to pull the cargo against a deck surface of the vehicle to prevent the cargo from shifting. Cargo that is not tied down can shift around during transport.

In this respect, it would be desirable to provide cargo retention systems for vehicles, for example that further facilitate holding the cargo in place.

### SUMMARY

In general, one aspect of the subject matter described in this disclosure may be embodied in a cargo retention system for a vehicle. The cargo retention system can include a cargo support structure including a cargo support surface, a fluid cavity, and a plurality of cargo retention columns coupled to the cargo support structure and moveable between a retracted position and an extended position with respect to the cargo support surface. The fluid cavity can be configured to receive a pressurized fluid for urging the plurality of cargo retention columns to move from the retracted position toward the extended position.

In another aspect, the subject matter may be embodied in a vehicle. The vehicle includes a cargo bed and a cargo retention system. The cargo retention system can include a cargo support structure including a cargo support surface, a fluid cavity, and a plurality of cargo retention columns coupled to the cargo support structure and moveable between a retracted position and an extended position with respect to the cargo support surface. The fluid cavity can be configured to receive a pressurized fluid for urging the plurality of cargo retention columns to move from the retracted position to or toward the extended position.

These and other embodiments may optionally include one or more of the following features.

The plurality of cargo retention columns can be arranged in a grid pattern.

Each retention column of the plurality of cargo retention columns can include a plurality of telescoping sleeves.

Each retention column of the plurality of cargo retention columns can include an elastic material configured to be inflated by the pressurized fluid. In various aspects, the cargo support structure can be made of an elastic material configured to be inflated by the pressurized fluid.

Each retention column of the plurality of cargo retention columns can be configured to translate along a central axis of the retention column between the retracted position toward the extended position. Each retention column of the plurality of cargo retention columns can be configured to rotate about the central axis to contact a cargo supported on the cargo support surface. Each retention column of the plurality of cargo retention columns can include a pin configured to contact the cargo. The pin can be configured to move from a stowed position to a deployed position in response to the retention column moving from the retracted position toward the extended position.

The cargo retention system can further include a position sensor configured to detect a position of at least one of the cargo retention columns. The control unit can control a fluid pressure in contact with the cargo retention column based on feedback from the position sensor.

The cargo retention system can further include a fluid source. The cargo retention system can further include a valve coupled between the fluid source and the fluid cavity. The cargo retention system can further include a fluid pump operatively coupled to the fluid source for pressurizing the pressurized fluid. The cargo retention system can further include a controller in electronic communication with the fluid pump and/or the valve. The cargo retention system can further include a user interface in electronic communication with the controller whereby the controller can (i) display a status of the cargo retention system and/or (ii) receive a user input.

The cargo support surface can define a bottom surface of the cargo bed.

In another aspect, the subject matter may be embodied in a method of using a cargo retention system for a vehicle. The method can include moving a pressurized fluid into a fluid cavity of a cargo support structure. The method can further include urging a plurality of cargo retention columns of the cargo support structure to move from a retracted position to an extended position with respect to a cargo support surface of the cargo support structure. The method can further include restricting lateral movement of an item using the plurality of cargo retention columns.

In various aspects, the method can further include rotating at least one cargo retention column of the plurality of cargo retention columns to contact the item while the at least one cargo retention column is in the extended position.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

Other apparatuses, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a perspective view of a vehicle according to an aspect of the present disclosure.

FIG. 2 illustrates a cargo bed region of the vehicle of FIG. 1 having a deployable cargo dependent retention system according to an aspect of the present disclosure.

FIG. 3 illustrates a cargo dependent retention system according to an aspect of the present disclosure.

FIG. 4 illustrates the cargo dependent retention system of FIG. 3 installed in the cargo bed of a vehicle according to an aspect of the present disclosure.

FIG. 5 illustrates a schematic view of a cargo dependent retention system according to an aspect of the present disclosure.

FIG. 6A illustrates a schematic side view of an item disposed on the cargo support structure of the cargo dependent retention system of FIG. 5 according to an aspect of the present disclosure.

FIG. 6B illustrates an enlarged view of the cargo support structure of FIG. 6A according to an aspect of the present disclosure.

FIG. 7A illustrates an example section view of the cargo support structure of FIG. 5 having a fluid cavity having reinforcing pillars according to an aspect of the present disclosure.

FIG. 7B illustrates an example plan view of the cargo support structure of FIG. 7A according to an aspect of the present disclosure.

FIG. 8A illustrates an example section view of the cargo support structure of FIG. 5 having a fluid cavity formed by a piping matrix according to an aspect of the present disclosure.

FIG. 8B illustrates an example plan view of the cargo support structure of FIG. 7A according to an aspect of the present disclosure.

FIG. 9A and FIG. 9B illustrate schematic side views of a retention column in a retracted position and an extended position, respectively, according to an aspect of the present disclosure.

FIG. 9C and FIG. 9D show top views of the retention column of FIG. 9A and FIG. 9B, respectively, according to an aspect of the present disclosure.

FIG. 10A and FIG. 10B illustrate schematic side views of a retention column in a retracted position and an extended position, respectively, according to an aspect of the present disclosure.

FIG. 10C and FIG. 10D show top views of the retention column of FIG. 10A and FIG. 10B, respectively, according to an aspect of the present disclosure.

FIG. 11A and FIG. 11B illustrate schematic side views of a retention column in a retracted position and an extended position, respectively, according to an aspect of the present disclosure.

FIG. 12A and FIG. 12B illustrate schematic side views of a retention column in a retracted position and an extended position, respectively, according to an aspect of the present disclosure.

FIG. 13A and FIG. 13B illustrate schematic side views of a retention column in a retracted position and an extended position, respectively, and having a mechanical stopper, according to an aspect of the present disclosure.

FIG. 14A and FIG. 14B illustrate schematic side and top views, respectively, of a retention column in an extended position and having a spring-biased mechanical stopper, according to an aspect of the present disclosure.

FIG. 15 illustrates a schematic side view of a retention column, and a position sensor configured to detect a position of the retention column, according to an aspect of the present disclosure.

### DETAILED DESCRIPTION

Disclosed herein are apparatus, systems, and methods for implementing a cargo retention system for a vehicle. The cargo retention system includes a cargo support structure including a fluid cavity, a cargo support surface, and a plurality of cargo retention columns coupled to the cargo support structure and moveable between a retracted position and an extended position with respect to the cargo support surface. The fluid cavity is configured to receive a pressurized fluid for urging the plurality of cargo retention columns to move from the retracted position to or toward the extended position. The cargo retention columns can be configured to secure one or more items on the cargo support surface to prevent or mitigate movement of the item(s) during transit.

The cargo retention columns can automatically conform to the shape of the cargo item(s) when deployed. In this manner, oddly shaped items are secured during transit. In various aspects, the cargo retention columns can include “fine tuning” deployable protrusions (referred to herein as pins) that can allow the cargo retention columns located around the periphery of the item(s) to reach/contact the item(s) for close tolerance securing of the item(s) during transit. The cargo retention columns can be rotated until the pins touch the item(s).

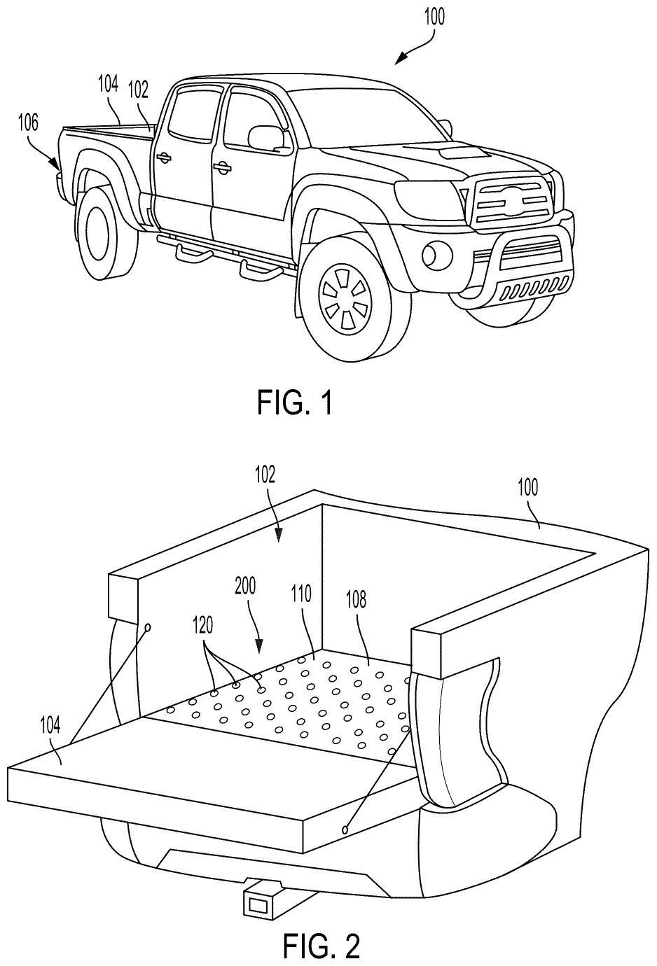

FIG. 1 illustrates a perspective view of an example vehicle 100 to be used with a deployable cargo dependent retention system, in accordance with various aspects. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a pick-up truck, an SUV, a UTV, a minivan, a station wagon, or other motor or battery driven vehicle. For example, the vehicle 100 may be an electric vehicle, a hybrid vehicle, a plug-in hybrid vehicle, a fuel cell vehicle, or any other type of vehicle that includes a motor/generator. FIG. 1 depicts a pick-up truck by example. However, a deployable cargo dependent retention system can be used in connection with any suitable vehicle, including for example watercraft, trains, aircraft, trailers, etc.

The vehicle 100 may be an autonomous or semi-autonomous vehicle having self-driving capabilities. The vehicle 100 may have a cargo bed 102 enclosed by a tailgate 104 from a rear end 106. The cargo bed 102 may have an open top or a closed top. The cargo bed 102 may be suitable to store and transport cargo. The cargo bed 102 may accommodate cargo. In various aspects, the tailgate 104 may enclose a trunk (e.g., for a sedan or SUV). In various aspects, the cargo bed 102 does not include a tailgate 104 (e.g., for a flatbed vehicle).

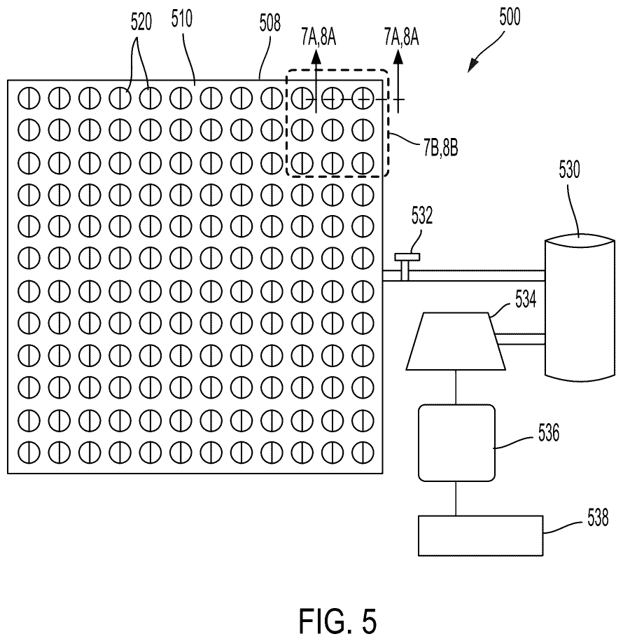

FIG. 2 shows a deployable cargo dependent retention system 200 built into the cargo bed 102. The cargo bed 102 can include a cargo support structure 108. The cargo support structure 108 can be formed integrally with the cargo bed 102. The cargo support structure 108 can include a cargo support surface 110. System 200 can include a plurality of cargo retention columns 120 coupled to the cargo support structure 108 and moveable between a retracted position and an extended position with respect to the cargo support surface 110. The cargo support structure 108 can include a fluid cavity whereby a position of the cargo retention columns 120 is controlled, as described herein in greater detail. The cargo retention columns 120 can be arranged in a grid pattern (e.g., having a plurality of rows and columns). The cargo retention columns 120 can be configured to move along respective axes that are oriented perpendicular to (i.e., normal to) the cargo support surface 110. The cargo retention columns 120 can be evenly spaced along the cargo support surface 110. The distribution of the cargo retention columns 120 can vary depending on the particular design of the retention system 200. The height of each of the cargo retention columns 120 can be the same in various examples. The height of the cargo retention columns 120 in the fully extended position can vary depending on the design parameters and/or application (e.g., depending on the item(s) being retained). As viewed from the top (e.g., see FIG. 5), the cargo retention columns 120 can have various shapes, such as a circular shape, a “T” shape, an “X” shape, an “I” shape, and “L” shape, or any other desired shape in accordance with various examples. The shape of the cargo retention columns 120 can be designed to optimize retention based on the application.

FIG. 3 shows a deployable cargo dependent retention system 300. System 300 can include a cargo support structure 308 including a cargo support surface 310. System 300 can include a plurality of cargo retention columns 320 coupled to the cargo support structure 308 and moveable between a retracted position and an extended position with respect to the cargo support surface 310. The cargo support structure 308 can be formed as a flat plate. The cargo support structure 308 can be rigid or can be a soft surface (e.g., to conform to the underlying support structure and/or to provide a soft surface for cargo to rest on). In this manner, the cargo support structure 308 can be placed over a cargo bed area of a vehicle. Accordingly, the cargo support structure 308 can be retrofitted into an existing vehicle, installed by the manufacturer, and/or installed by a user as an aftermarket accessory). The cargo support structure 308 can include a fluid cavity whereby a position of the cargo retention columns 320 is controlled, as described herein in greater detail. The cargo retention columns 320 can be arranged in a grid pattern (e.g., having a plurality of rows and columns). The cargo retention columns 320 can be configured to move along respective axes that are oriented perpendicular to (i.e., normal to) the cargo support surface 310.

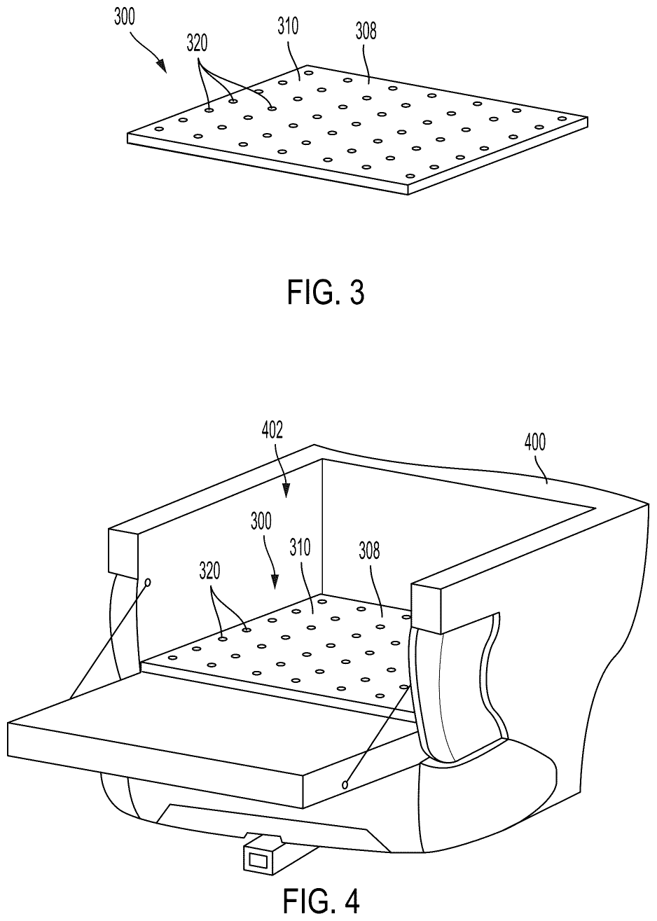

FIG. 4 shows the deployable cargo dependent retention system 300 installed over a cargo bed 402 of a vehicle 400. The vehicle 400 can be similar to the vehicle 100 described herein. The cargo support surface 310 can define a bottom surface of the cargo bed 402. The system 300 can be configured to secure cargo loaded onto the cargo bed 402 (i.e., on top of the system 300) of the vehicle 400. In this manner, movement of the cargo is minimized during transport.

FIG. 5 shows a schematic view of a cargo dependent retention system 500, in accordance with various aspects. The system 500 can include a cargo support structure 508. The cargo support structure 508 can be similar to the cargo support structure of the system 200 described with respect to FIG. 2 or the cargo support structure of the system 300 described with respect to FIG. 3 and FIG. 4, in accordance with various aspects. The cargo support structure 508 can include a cargo support surface 510. The cargo support structure 508 can include a plurality of retention columns 520.

The system 500 can include a fluid source 530 in fluid communication with the cargo support structure 508. The fluid source 530 can be a storage container for storing a fluid for the system 500. The system 500 can be a pneumatic system or a hydraulic system. In this regard, the fluid source 530 can be configured to store a gas (e.g., air, nitrogen, etc.) or can be configured to store a liquid (e.g., water, a hydraulic fluid, etc.). The system 500 can include a valve 532 coupled between the fluid source 530 and a fluid cavity of the cargo support structure 508. The cargo support structure 508 can include a fluid pump 534 operatively coupled to the fluid source 530 for pressurizing a fluid. The fluid pump 534 can be an electric fluid pump (e.g., powered by an electric motor) or an automotive belt-driven centrifugal pump (e.g., powered by the vehicle's engine) depending on the desired design. The cargo support structure 508 can be configured to receive the pressurized fluid from the fluid source 530 for urging the plurality of cargo retention columns 520 to move between a retracted position and an extended position.

The system 500 can include a control unit 536. The control unit 536 can include a user interface (e.g., a touch screen, a button, a knob, a switch, or the like). In various aspects, the control unit 536 includes one or more controllers (e.g., processors) and one or more tangible, non-transitory memories capable of implementing digital or programmatic logic. In various aspects, for example, the one or more controllers are one or more of a general-purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various aspects, the control unit 536 controls, at least various parts of, the fluid pressure of, and operation of various components of, the system 500. For example, the control unit 536 controls the pump 534 to control a position of the cargo retention columns 520 (e.g., stowed/retracted or deployed/extended). The control unit 536 may display a status of the cargo retention system 500. The control unit 536 may receive a user input for controlling the cargo retention system 500.

The control unit 536 can be powered by a power supply 538. The power supply 538 can be a battery or any other suitable power supply. In various aspects, the control unit 536 is powered by the vehicle's power supply (e.g., a vehicle battery). In various aspects, the control unit 536 is powered by a dedicated power supply.

The control unit 536 can be in electronic communication with the power supply 538, the pump 534, and/or the valve 532. As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”).

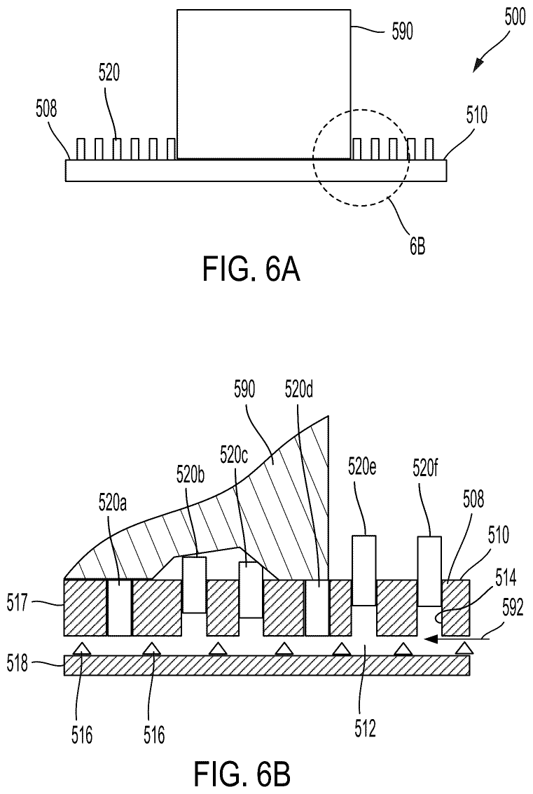

FIG. 6A and FIG. 6B show schematic side views of the cargo dependent retention system 500 with a piece of cargo 590 loaded onto the cargo support surface 510 of the cargo support structure 508, in accordance with various aspects. With particular focus on FIG. 6B, the cargo support structure 508 can include a plurality of apertures 514. Each aperture 514 can house a cargo retention column 520. The apertures 514 can be in fluid communication with a fluid cavity 512. As pressurized fluid (represented by arrow 592) enters into the fluid cavity 512 of the cargo support structure 508, the retention columns 520 can be urged to extend from the cargo support surface 510. Some of the retention columns 520 (e.g., see cargo retention column 520a and cargo retention column 520d) may be prevented from extending from the cargo support surface 510 under the weight of the cargo 590. In various aspects, the control unit 536 (see FIG. 5) can detect the cargo 590 above the cargo retention column 520a. The height of the cargo retention column 520a can be controlled via the control unit 536, for example by opening and or closing valves 516 located throughout the fluid cavity 512. In this regard, the valves 516 can be moved between open and closed positions to control fluid flow and/or fluid pressure that each cargo retention column 520 receives.

Some of the retention columns 520 (e.g., see cargo retention column 520b and cargo retention column 520c) may only partially extend from the cargo support surface 510 due to being blocked from fully extending by the cargo 590. For example, the retention columns 520 can extend until they contact the cargo 590. The fluid pressure of the pressurized fluid 592 can be controlled so that the bias of the pressurized fluid is insufficient to overcome the weight of the cargo 590, so as to not lift the cargo 590 off of the cargo support surface 510. Instead, the fluid pressure of the pressurized fluid 592 can be controlled so that the retention columns 520 remain in contact with the cargo 590 in a partially extended position to secure the cargo 590 in place during transit. In this manner, the retention columns 520 can conform to a shape/geometry of the cargo 590 to secure the cargo 590 in place. In this manner, the final retention surface (comprised of the cargo support surface 510 and the retention columns 520) may not be planar. The retention can occur at the cargo periphery (see cargo retention column 520e) and at other surfaces on the bottom of the cargo 590 (see cargo retention column 520b and cargo retention column 520c). The height of the retention columns 520 can be selectively controlled by opening and/or closing the valves 516 to control a fluid pressure in fluid communication with the retention columns 520.

In various aspects, one or more of the retention columns 520 may extend to a fully extended position (e.g., see cargo retention column 520e and cargo retention column 520f). Retention columns 520 surrounding the cargo 590 can extend to secure the cargo 590 from shifting laterally during transit). For example, the cargo retention column 520e can serve as a stopping surface configured to contact the cargo 590 to stop the cargo 590 from moving laterally with respect to the cargo support surface 510.

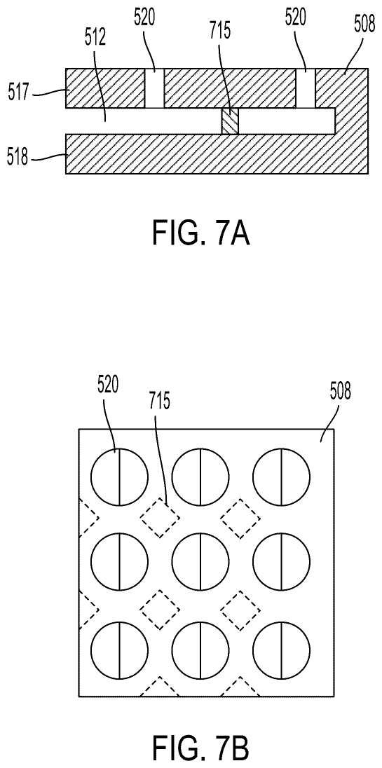

With reference to FIG. 7A and FIG. 7B, the fluid cavity 512 can be open and expand across the length and width of the cargo support structure 508. Reinforcing pillars 715 can be disposed throughout the fluid cavity 512 in a grid system to support the top sheet 517 of the cargo support structure 508 with respect to the bottom sheet 518 of the cargo support structure 508.

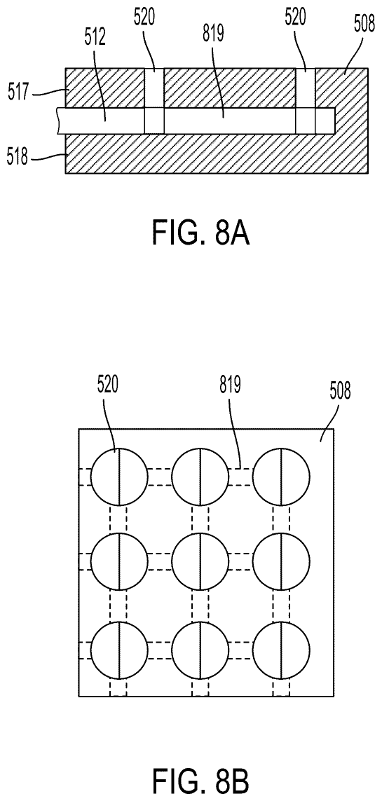

With reference to FIG. 8A and FIG. 8B, the fluid cavity 512 can be defined by a piped system including a network of pipes 819. The pipes 819 can carry the pressurized fluid to each of the retention columns 520. One or more valves may be located within the piping matrix, each at each cargo retention column 520 (e.g., 1, 2, 3, or 4 fluid inlets at each retention column). The pipes 819 can receive pressurized fluid via the main valve (see valve 532 of FIG. 5) from the external fluid source 530.

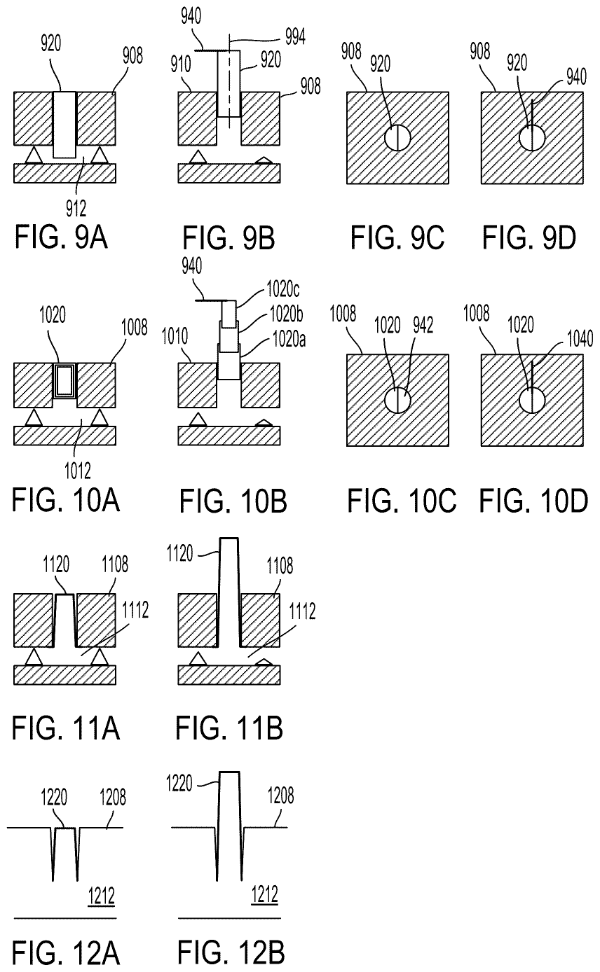

FIG. 9A and FIG. 9B show schematic side views of a cargo retention column 920 in a retracted position and an extended position, respectively, in accordance with various aspects. FIG. 9C and FIG. 9D show top views of the cargo retention column 920 of FIG. 9A and FIG. 9B, respectively, in accordance with various aspects. The cargo retention column 920 is shown installed in a cargo support structure 908, which can be similar to any of the cargo support structures described herein. The cargo support structure 908 can include a fluid cavity 912. The cargo retention column 920 can be configured as a linear piston or rod.

In various aspects, as the cargo retention column 920 moves toward the extended position along a central axis 994 of the cargo retention column 920, a pin 940 can extend laterally (i.e., perpendicular to the central axis 994) from the cargo retention column 920. In various aspects, the cargo retention column 920 can rotate to cause the pin 940 to extend from the cargo retention column 920. In various aspects, the pin 940 can rotate away from the cargo retention column 920. In various aspects, the pin 940 can translate from the cargo retention column 920. The pin 940 can extend until the pin 940 contacts a piece of cargo. In this manner, the cargo retention column 920 can deploy the pin 940 for “fine tuning” of the retention system to aide in securing cargo to the cargo support structure 908. The cargo retention column 920 can be configured to rotate about the central axis 994 to contact a cargo supported on the cargo support surface 910. The cargo retention column 920 can be configured to rotate about the central axis 994 until the pin 940 contacts the cargo.

FIG. 10A and FIG. 10B show schematic side views of a retention column 1020 in a retracted position and an extended position, respectively, in accordance with various aspects. FIG. 10C and FIG. 10D show top views of the retention column 1020 of FIG. 10A and FIG. 10B, respectively, in accordance with various aspects. The retention column 1020 is shown installed in a cargo support structure 1008, which can be similar to any of the cargo support structures described herein. The cargo support structure 1008 can include a fluid cavity 1012. The retention column 1020 can include a plurality of telescoping sleeves (e.g., a first sleeve 1020a, a second sleeve 1020b, and a third sleeve 1020c).

In various aspects, as the retention column 1020 moves toward the extended position along a central axis of the retention column 1020, a pin 1040 can extend laterally from the retention column 1020. The pin 1040 can be similar to the pin 940 described with respect to FIG. 9A through FIG. 9D. In various aspects, the telescoping sleeves (e.g., the first sleeve 1020a, the second sleeve 1020b, and the third sleeve 1020c) can be threadingly coupled to one another. In this regard, the telescoping sleeves (e.g., the first sleeve 1020a, the second sleeve 1020b, and the third sleeve 1020c) can rotate about their respective central axes as they extend. The pin 1040 can be deployed in response to the rotation of the telescoping sleeves. The retention column 1020 can be configured to rotate about its central axis to contact a cargo supported on the cargo support surface 1010. The retention column 1020 can be configured to rotate about the central axis until the pin 1040 contacts the cargo.

In various aspects, and with momentary reference to FIG. 10C, the top of the retention column 1020 can have a replaceable pad 942 attached to alter the friction/durometer of the surface of the retention column 1020 depending on what type of cargo is being transported. Although described with respect to the retention column 1020, any of the retention columns described herein can be configured with the replaceable pad 942.

FIG. 11A and FIG. 11B show schematic side views of a retention column 1120 in a retracted position and an extended position, respectively, in accordance with various aspects. The retention column 1120 is shown installed in a cargo support structure 1108, which can be similar to any of the cargo support structures described herein. The cargo support structure 1108 can include a fluid cavity 1112. The retention column 1120 can be made of a flexible elastic material. For example, the retention column 1120 can be made of an inflatable balloon-like material (e.g., a butyl rubber material, a latex material, or the like). The pressurized fluid can be configured to inflate the retention column 1120 to cause the retention column 1120 to extend from the cargo support structure 1108. A height of the retention column 1120 can be set by the internal fluid pressure balance to rigidity of the retention column 1120 material rigidity (tensile strength). Accordingly, the fluid pressure in the fluid cavity 1112 in FIG. 11A is less than the fluid pressure in the fluid cavity 1112 in FIG. 11B.

FIG. 12A and FIG. 12B show schematic side views of a retention column 1220 in a retracted position and an extended position, respectively, in accordance with various aspects. The retention column 1220 is shown installed in a cargo support structure 1208, which can be similar to any of the cargo support structures described herein. The cargo support structure 1208 can include a fluid cavity 1212. The cargo support structure 1208 can be made of a thick elastic material (e.g., plastic, rubber, or the like). The retention column 1220 can be made of a flexible elastic material. For example, the retention column 1220 can be made of an inflatable balloon-like material (e.g., a butyl rubber material, a latex material, or the like). The cargo support structure 1208 can be made of a material that is less elastic and/or more rigid than that of the retention column 1220. In this regard, the cargo support structure 1208 can be inflatable. The pressurized fluid can be configured to inflate the retention column 1220 to cause the retention column 1220 to extend from the cargo support structure 1208. A height of the retention column 1220 can be set by the internal fluid pressure balance to rigidity of the retention column 1220 material rigidity (tensile strength). Accordingly, the fluid pressure in the fluid cavity 1212 in FIG. 12A is less than the fluid pressure in the fluid cavity 1212 in FIG. 12B. The cargo support structure 1208 can assume a soft surface that is completely inflatable (e.g., not unlike an air mattress).

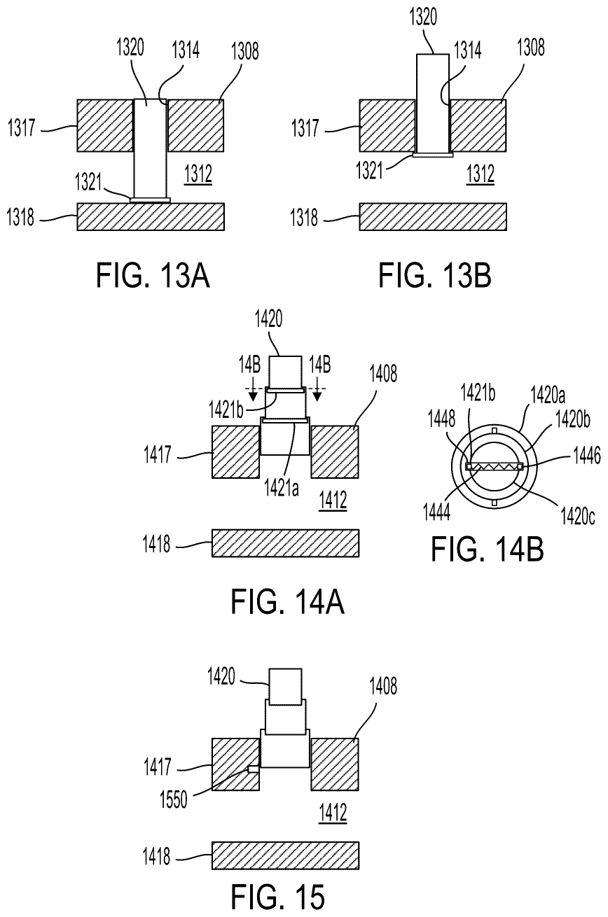

FIG. 13A and FIG. 13B show schematic side views of a retention column 1320 in a retracted position and an extended position, respectively, in accordance with various aspects. The retention column 1320 is shown installed in a cargo support structure 1308, which can be similar to any of the cargo support structures described herein. The cargo support structure 1308 can include a fluid cavity 1312. The retention column 1320 can be similar to any of the retention columns described herein. The retention column 1320 can include a mechanical stopper 1321. The mechanical stopper 1321 can be a flange disposed at an end of the retention column 1320. The mechanical stopper 1321 can be configured to retain the retention column 1320 within the aperture 1314. The mechanical stopper 1321 can be configured to contact the top sheet 1317 of the cargo support structure 1308 to stop the retention column 1320 from extending past the fully extended position (see FIG. 13B). The mechanical stopper 1321 can be configured to contact the bottom sheet 1318 of the cargo support structure 1308 to stop the retention column 1320 from retracting past the fully retracted position (see FIG. 13A).

FIG. 14A and FIG. 14B show schematic side views of a cargo retention column 1420 in a retracted position and an extended position, respectively, in accordance with various aspects. The cargo retention column 1420 is shown installed in a cargo support structure 1408, which can be similar to any of the cargo support structures described herein. The cargo support structure 1408 can include a fluid cavity 1412. The cargo retention column 1420 can be similar to any of the retention columns described herein. The cargo retention column 1420 can be similar to the retention column 1020 described with respect to FIG. 10A through FIG. 10D. The cargo retention column 1420 can include a plurality of telescoping sleeves (e.g., a first sleeve 1420a, a second sleeve 1420b, and a third sleeve 1420c). The cargo retention column 1420 can include one or more mechanical stoppers 1421. The cargo retention column 1420 can include a mechanical stopper 1421a disposed at an end of the second sleeve 1420b. The cargo retention column 1420 can include a mechanical stopper 1421b disposed at an end of the third sleeve 1420c.

With reference to FIG. 14B, the mechanical stopper 1421b can include a spring-loaded stopper including a spring member 1444 configured to bias one or more mechanical stops 1446 (e.g., tabs) outward. The mechanical stops can be received in a recess 1448 disposed on the second sleeve 1420b. The mechanical stopper 1421a can be similar to the mechanical stopper 1421b.

With reference to FIG. 15, an electrical sensor 1550 can be provided for sensing a position of the cargo retention column 1420. For example, the sensor 1550 can detect when the cargo retention column 1420 has fully extended. In various aspects, the sensor 1550 can detect when the cargo retention column 1420 has translated past the sensor 1550. The sensor 1550 can be a position sensor. The sensor 1550 can include a camera, radar, sonar, or any sensor suitable for acquiring motion and/or position data about the cargo retention column 1420. The control unit 536 (see FIG. 5) can be in electronic communication with the sensor 1550. The control unit 536 can control a fluid pressure in contact with the cargo retention column 1420 based on feedback from the sensor 1550 to control a position of the cargo retention column 1420. Although illustrated in connection with a telescoping retention column, the sensor 1550 can be used with any suitable style of retention column.

A method of using a cargo retention system for a vehicle can include moving a pressurized fluid into a fluid cavity of a cargo support structure. For example, with momentary reference to FIG. 5, the valve 532 can be opened to allow a pressurized fluid into a fluid cavity (see fluid cavity 512 of FIG. 6B) of the cargo support structure 508.

The method can further include urging a plurality of cargo retention columns of the cargo support structure to move from a retracted position to an extended position with respect to a cargo support surface of the cargo support structure. For example, with momentary reference to FIG. 6B, the pressurized fluid 592 can urge the cargo retention columns 520 of the cargo support structure 508 to move from a retracted position (e.g., see cargo retention column 520a) to an extended position (e.g., see cargo retention column 520e) with respect to a cargo support surface 510 of the cargo support structure 508.

The method can further include restricting lateral movement of an item using the plurality of cargo retention columns. For example, with momentary reference to FIG. 6B, the cargo retention columns 520 can restrict lateral movement of the cargo 590.

The method can further include rotating at least one cargo retention column of the plurality of cargo retention columns to contact the item with the cargo retention column while the at least one cargo retention column is in the extended position. For example, with momentary reference to FIG. 9B, the cargo retention column 920 can be rotated about the central axis 994 to contact an item (e.g., the cargo 590 of FIG. 6A). For example, the cargo retention column 920 can be rotated about the central axis 994 to contact the item with the pin 940.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.”

What is claimed is:

1. A cargo retention system for a vehicle, the cargo retention system comprising:
a cargo support structure including a cargo support surface, a fluid cavity, and a plurality of cargo retention columns coupled to the cargo support structure and moveable between a retracted position and an extended position with respect to the cargo support surface; and
the fluid cavity is configured to receive a pressurized fluid for urging the plurality of cargo retention columns to move from the retracted position toward the extended position.

2. The cargo retention system of claim 1, wherein the plurality of cargo retention columns are arranged in a grid pattern.

3. The cargo retention system of claim 1, wherein each retention column of the plurality of cargo retention columns comprises a plurality of telescoping sleeves.

4. The cargo retention system of claim 1, wherein each retention column of the plurality of cargo retention columns comprises an elastic material configured to be inflated by the pressurized fluid.

5. The cargo retention system of claim 1, wherein the cargo support structure comprises an elastic material configured to be inflated by the pressurized fluid.

6. The cargo retention system of claim 1, wherein each retention column of the plurality of cargo retention columns is configured to translate along a central axis of the retention column between the retracted position toward the extended position, and each retention column of the plurality of cargo retention columns is configured to rotate about the central axis to contact a cargo supported on the cargo support surface.

7. The cargo retention system of claim 6, wherein each retention column of the plurality of cargo retention columns includes a pin configured to contact the cargo, and the pin is configured to move from a stowed position to a deployed position in response to the retention column moving from the retracted position toward the extended position.

8. The cargo retention system of claim 7, further comprising a sensor configured to detect a position of a retention column of the plurality of cargo retention.

9. The cargo retention system of claim 1, further comprising:
a fluid source;
a valve coupled between the fluid source and the fluid cavity; and
a fluid pump operatively coupled to the fluid source for pressurizing the pressurized fluid.

10. The cargo retention system of claim 9, further comprising:
a controller in electronic communication with at least one of the fluid pump or the valve; and
a user interface in electronic communication with the controller whereby the controller can at least one of (i) display a status of the cargo retention system or (ii) receive a user input.

11. A vehicle comprising:
a cargo bed;
a cargo retention system comprising:
a cargo support structure including a cargo support surface, a fluid cavity, and a plurality of cargo retention columns coupled to the cargo support structure and moveable between a retracted position and an extended position with respect to the cargo support surface; and
the fluid cavity is configured to receive a pressurized fluid for urging the plurality of cargo retention columns to move from the retracted position toward the extended position.

12. The vehicle of claim 11, wherein the cargo support surface defines a bottom surface of the cargo bed.

13. The vehicle of claim 11, wherein each retention column of the plurality of cargo retention columns comprises a plurality of telescoping sleeves.

14. The vehicle of claim 11, wherein each retention column of the plurality of cargo retention columns comprises an elastic material configured to be inflated by the pressurized fluid.

15. The vehicle of claim 11, wherein each retention column of the plurality of cargo retention columns is configured to translate along a central axis of the retention column between the retracted position toward the extended position, and each retention column of the plurality of cargo retention columns is configured to rotate about the central axis to contact a cargo supported on the cargo support surface.

16. The vehicle of claim 15, wherein each retention column of the plurality of cargo retention columns includes a deployable pin configured to contact the cargo.

17. The vehicle of claim 11, further comprising:
a fluid source;
a valve coupled between the fluid source and the fluid cavity; and
a fluid pump operatively coupled to the fluid source for pressurizing the pressurized fluid.

18. The vehicle of claim 17, further comprising:
a controller in electronic communication with at least one of the fluid pump or the valve; and
a user interface in electronic communication with the controller whereby the controller can at least one of (i) display a status of the cargo retention system or (ii) receive a user input.

19. A method of using a cargo retention system for a vehicle, the method comprising:
moving a pressurized fluid into a fluid cavity of a cargo support structure;
urging a plurality of cargo retention columns of the cargo support structure to move from a retracted position to an extended position with respect to a cargo support surface of the cargo support structure; and
restricting lateral movement of an item using the plurality of cargo retention columns.

20. The method of claim 19, further comprising rotating at least one cargo retention column of the plurality of cargo retention columns to contact the item while the at least one cargo retention column is in the extended position.
